(19) United States
(12) Patent Application Publication
(10) Pub. No.: US 2006/0185700 A1
(43) Pub. Date: Aug. 24, 2006

(54) Dishwasher, and gasket for the same

(75) Inventor: Jhe Hyouk Lee, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS, INC., Youngsungpo-gu (KR)

(21) Appl. No.: 11/337,797

(22) Filed: Jan. 24, 2006

(30) Foreign Application Priority Data
Jan. 25, 2005 (KR) 10-2005-006633

(51) Int. Cl. B08B 3/02

(52) U.S. Cl. 134/198; 134/200; 134/184

(57) ABSTRACT

A dishwasher and a gasket for the dishwasher are provided. The dishwasher and the gasket include a gasket body forming a hole through which a guide pin and a guide sleeve insert, and a packing member that seals a gap between the gasket body and the guide sleeve in order to prevent leakage between a water guide and a spray arm holder.

### BACKGROUND OF THE INVENTION

1. Field of the Invention

The present invention relates to a dishwasher, and more particularly, to a gasket capable of preventing leakage between a nozzle holder and a water guide, and a dishwasher using the same.

2. Description of the Related Art

A dishwasher is a home appliance that sprays high-pressure wash liquid through spray nozzles to wash and remove food residue left on surfaces of dishes.

Specifically, a dishwasher includes a tub forming a wash compartment, and a sump installed at the bottom of the tub for storing wash liquid. Installed inside the sump is a wash pump that pumps wash liquid to the spray nozzles. The wash liquid pumped to the spray nozzles is discharged under high pressure through spray holes at the ends of the nozzles. The high-pressure wash liquid spray collides with the surfaces of dishes, so that food residue and other impurities on the dishes fall to the floor of the tub.

FIG. 1 is an exploded perspective view of a connecting portion between a water guide and an upper spray arm holder in a dishwasher according to the related art.

Referring to FIG. 1, in order to couple an upper spray arm holder to a water guide in a dishwasher according to the related art, a gasket assembly is inserted therebetween.

Specifically, the coupling structure of an upper spray arm holder according to the related art includes a spray arm holder 30 for rotatably mounting the upper spray arm to an end thereof, a gasket 20 coupled at the other end of the spray arm holder 30 for preventing leakage of wash liquid, and a water guide 10 on which the spray arm holder 30 is mounted.

In further detail, the gasket 20 includes a gasket body 21, a packing member 22 made of a rubber material inserted between the gasket body 21 and the rear of the nozzle holder 30, and a packing cover 23 disposed at the front of the packing member 22 for compressing the packing member 22. The water guide 10 has a hollow interior for wash liquid to flow through, an upper pin 11 and a lower pin 12 projecting a predetermined distance from the front thereof for supporting the spray arm holder 30, and a guide sleeve 13 disposed below the lower pin 12 for wash liquid to be discharged through. The packing member 22 has a packing mouth 24 protruding in a forward direction with an open end. The packing mouth 24 is closed when wash liquid does not flow through it, and is opened by means of water pressure when wash liquid flows. A pin insert hole 31 is formed at the rear end of the spray arm holder 30 and the upper portion of the gasket 20 for the upper pin 11 or the lower pin 12 to be inserted through. The packing cover 23 has a hole formed at the location through which the packing mouth 24 is formed so that the latter can pass therethrough. The gasket body 21 has a hole formed below the pin insert hole 31 at a location where the packing mouth 24 is formed, so that the lower pin 12 and/or the guide sleeve 13 insert therethrough.

In the above structure, when the upper pin 11 inserts through the pin insert hole 31 of the spray arm holder 30, the lower pin 12 and the guide sleeve 13 insert into the packing mouths 24. Wash liquid that is discharged through the guide sleeve 13 opens the packing mouth 24 with water pressure and is discharged through the open packing mouth 24 to flow to the upper spray arm through the spray arm holder 30.

However, if the lower pin 12 is inserted in the pin insert hole 31, the guide sleeve 13 is inserted into the upper of the two packing mouths 24. The lower packing mouth 24 does not have anything inserted therein.

In this case, the problem outlined below arises in a dishwasher according to the related art.

First, because there is no pin or guide sleeve inserted in the lower packing mouth 24, a portion of wash liquid that is discharged through the upper packing mouth 24 leaks through the lower packing mouth 24.

Second, because wash liquid enters the spray arm holder 30 through the packing mouth 24, the amount of wash liquid discharged into the spray arm holder 30 is reduced. Accordingly, the water pressure of wash liquid discharged into the spray arm holder 30 is reduced, so that the spraying pressure of wash liquid sprayed from the spray arm is reduced.

Third, in order to prevent wash liquid from leaking through the packing mouth 24, the packing mouth 24 can be manufactured so that it does not open beyond a certain water pressure, which complicates the manufacturing process.

### SUMMARY OF THE INVENTION

Accordingly, the present invention is directed to a dishwasher that substantially obviates one or more problems due to limitations and disadvantages of the related art.

An object of the present invention is to provide a dishwasher with an improved gasket structure interposed between a spray arm holder and water guide thereof, that minimizes water pressure loss of wash liquid discharged to the spray arm holder, and prevents leakage of wash liquid from the coupling region of the spray arm holder and the water guide.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dishwasher including: a water guide; a spray arm holder for receiving wash liquid flowing through the water guide; a guide pin protruding from the water guide; a guide sleeve providing a passage for a flow of wash liquid from the water guide to the spray arm holder; and a gasket including a gasket body forming a hole for inserting the guide pin and the guide sleeve through, and a packing member for sealing a gap between the gasket body and the guide sleeve to prevent leakage between the water guide and the spray arm holder.

In another aspect of the present invention, there is provided a gasket of a dishwasher having a spray arm holder, a guide sleeve providing a passage for a flow of wash liquid to the spray arm holder, and a water guide forming a guide pin protruding therefrom, wherein the gasket includes: a gasket body forming a hole for inserting the guide pin and the guide sleeve therethrough; and a packing member for sealing a gap between the gasket body and the guide sleeve to prevent leakage between the water guide and the spray arm holder.

In a further aspect of the present invention, there is provided a dishwasher including: a water guide; a spray arm holder for receiving wash liquid flowing through the water guide; a guide sleeve providing a passage for a flow of wash liquid from the water guide to the spray arm holder; a guide pin formed above and below the guide sleeve; and a gasket including a gasket body forming a hole for inserting the guide pin and the guide sleeve through, a packing member for sealing a gap between the gasket body and the guide sleeve to prevent leakage between the water guide and the spray arm holder, and a packing cover for pressing against the packing member.

The dishwasher according to the present invention provides an improved structure for a packing member capable of preventing leakage of wash liquid from a connecting region as the wash liquid flows from the water guide to the upper spray arm holder.

Therefore, even if the coupling position of the spray arm holder on the water guide should change, leakage from the connecting area can be prevented.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of a connecting portion between a water guide and an upper spray arm holder in a dishwasher according to the related art;

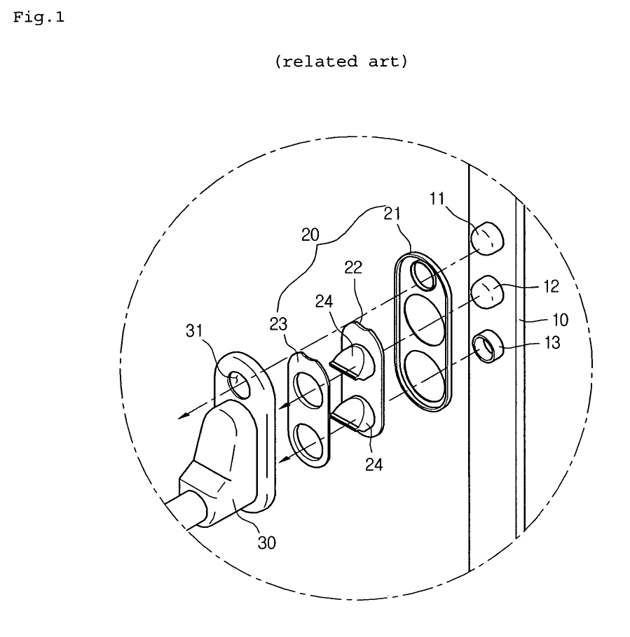

FIG. 2 is a schematic sectional view of a dishwasher according to the present invention;

FIG. 3 is a perspective view of a structure inside a dishwasher according to the present invention for spraying wash liquid;

FIG. 4 is an exploded perspective view of section A in FIG. 3; and

FIG. 5 is a sectional view taken along line I-I′ in FIG. 3.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

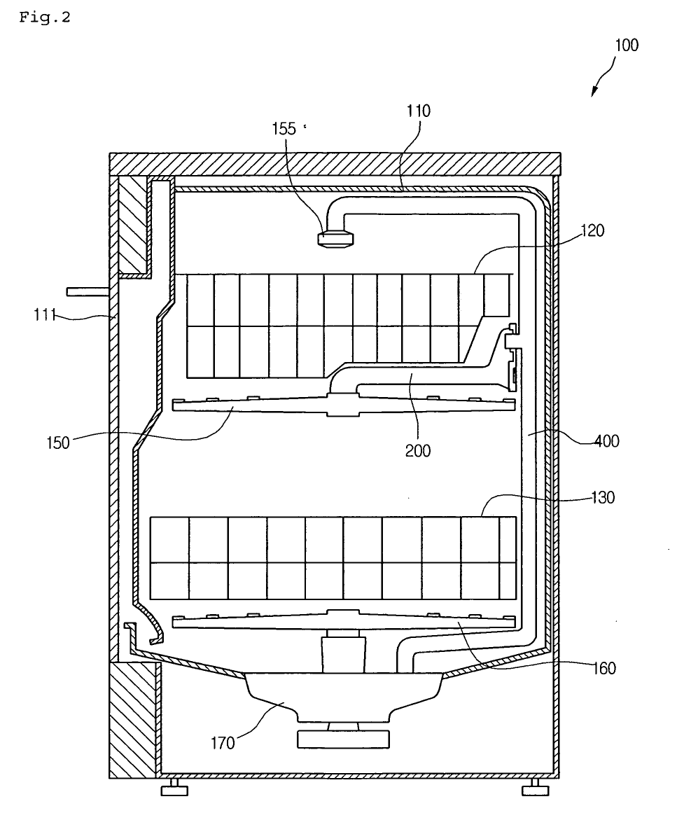

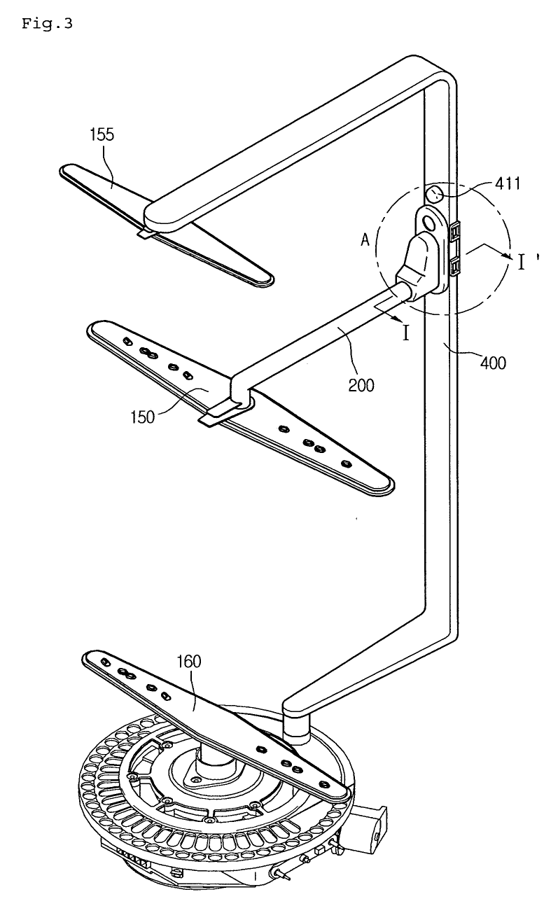

FIG. 2 is a schematic sectional view of a dishwasher according to the present invention, and FIG. 3 is a perspective view of a structure inside a dishwasher according to the present invention for spraying wash liquid.

Referring to FIGS. 2 and 3, a dishwasher 100 includes a tub 110 forming the outer shape of the dishwasher 100 and a door 111 installed at the front of the tub 110 for opening and closing the tub 110.

A sump 170 is installed at the inner bottom portion of the tub 110 for pumping wash liquid. The wash liquid pumped by the sump 170 flows through a water guide 400. The flowing wash liquid is sprayed through a lower spray arm 160, an upper spray arm 150, and a top spray arm 155. Specifically, the lower spray arm 160 is installed at the central portion of the sump 170 to spray wash liquid. The upper spray arm 150 branches off from a point along the water guide 400 to spray wash liquid. The top spray arm 155 is coupled to the top end of the water guide 400 to spray wash liquid in a downward direction.

An upper rack 120 for storing dishes is installed between the top spray arm 155 and the upper spray arm 150. A lower rack 130 is installed between the upper spray arm 150 and the lower spray arm 160. In more detail, the upper spray arm 150 is connected to the end of the spray arm holder 200 extending a predetermined distance from the water guide 400. The spray arm holder 200 is installed on the front of the water guide 400.

The operation of the above-structured dishwasher 100 will now be described.

First, when the dishwasher 100 is activated, wash liquid flows into the sump 170. Then, when the wash liquid reaches a preset water level in the sump 170, a wash motor installed below the sump operates to pump the wash liquid. The wash liquid pumped by the wash motor flows alternately to the water guide 400 and the lower spray arm 160.

In further detail, a portion of the wash liquid that flows through the water guide 400 flows to the upper spray arm 150, and the remaining portion flows to the top spray arm 155. The wash liquid that flows to the upper, top, and lower spray arms 150, 155, and 160 is sprayed through spray holes formed in the spray arms into the tub 110. The spray pressure of the wash liquid sprayed through the spray holes washes dishes stored in the upper rack 120 and/or the lower rack 130.

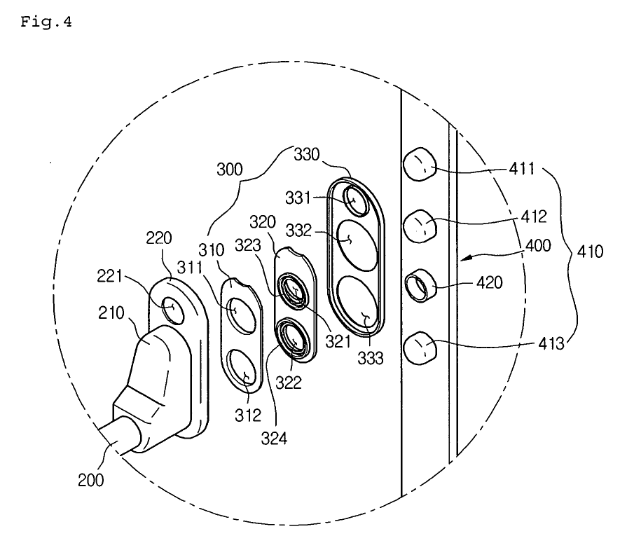

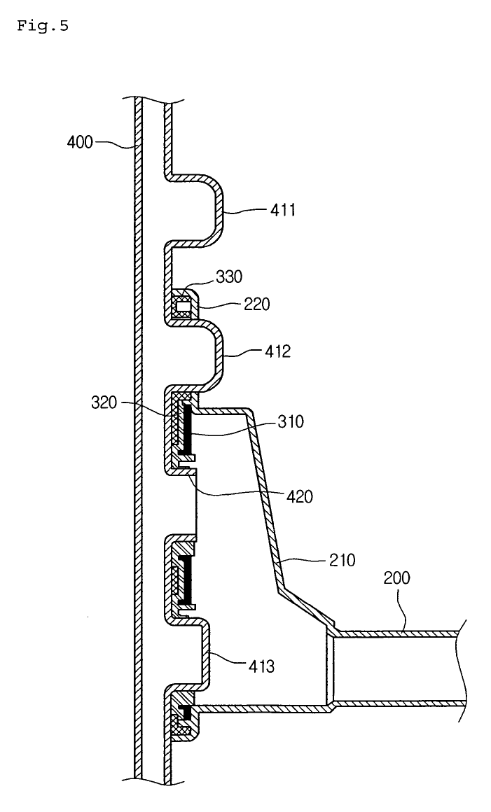

FIG. 4 is an exploded perspective view of section A in FIG. 3, and FIG. 5 is a sectional view taken along line I-I′ in FIG. 3.

Referring to FIGS. 4 and 5, a gasket 300 is installed behind a spray arm holder 200.

The water guide 400 is disposed behind the gasket 300. When assembly is completed, the spray arm holder 200 and the water guide 400 are coupled with the gasket 300 interposed therebetween.

The spray arm holder 200 includes a holder body 210 formed at its rear, and a gasket cover 220 formed behind the holder body 210 for installing the gasket 300.

In detail, a guide pin insert hole 221 is formed in the upper portion of the gasket cover 220. The guide pin insert hole 221 has a predetermined diameter for inserting a guide pin 410 protruding from the front of the water guide 400.

The gasket 300 includes a gasket body 330, a packing member 320 made of rubber mounted at the front of the gasket body 330, and a packing cover 310 mounted at the front of the packing member 320 for compressing the packing member 320.

A guide pin insert hole 331 is also formed in the upper portion of the gasket body 330. The guide pin insert hole 331 is formed with a predetermined diameter for inserting the guide pin 410 through. An upper hole 332 and a lower hole 333 are formed below the guide pin insert hole 331. A guide pin 410 and/or a guide sleeve (to be described below) are inserted into the upper and lower holes 332 and 333.

The gasket body 330 has the same shape as the gasket cover 220 formed behind the spray arm holder 200, so that the gasket cover 220 can be precisely coupled.

The packing member 320 includes an upper hole 321 that adheres to the upper hole 332 of the gasket body 330, and a lower hole 322 that adheres to the lower hole 333 of the gasket body 330. Packing sleeves 323 and 324 are respectively provided to extend a predetermined height from the front perimeters of the upper hole 321 and the lower hole 322 in order to insert into holes (to be described below) formed in the packing cover 310.

The packing cover 310 includes an upper hole 311 having the same diameter as the outer diameter of the packing sleeve 323 formed on the outer perimeter of the upper hole 321, and a lower hole 312 having the same diameter as the outer diameter of the packing sleeve 324 formed on the outer perimeter of the lower hole 322.

The front portion of the water guide 400, on which the spray arm holder 200 is mounted, has a guide pin 410 of a predetermined diameter and protruding a predetermined distance. Specifically, the guide pin 410 may include an upper, middle, and lower pin 411, 412, and 413.

The upper pin 411 may insert into the guide pin insert hole 331 of the gasket body 330 and the guide pin insert hole 221 of the gasket cover 220. The middle pin 412 is formed in the same dimensions as the upper pin 411 therebelow. The lower pin 413 is formed with the same diameter as the middle pin 412 therebelow. A guide sleeve 420 is formed between the middle pin 412 and the lower pin 413. The guide sleeve 420 branches wash liquid flowing through the water guide 400 to the spray arm holder 200.

The process of assembling the spray arm holder 200 to the water guide 400 will hereinafter be described.

First, when the upper pin 411 is inserted in the guide pin insert hole 221 of the spray arm holder 200, the upper pin 411 passes through the guide pin insert hole 331 of the gasket body 330. The middle pin 412 inserts through the upper hole 332 of the gasket body 330, the upper hole 321 of the packing member, and the upper hole 311 of the packing cover 310. The guide sleeve 420 inserts into the lower hole 333 of the gasket body 330, the lower hole 322 of the packing member 320, and the lower hole 312 of the packing cover 310.

Here, the respective inner surfaces of the packing sleeves 323 and 324 of the packing member 320 are pressed against by the outer surfaces of the middle pin 412 and the guide sleeve 420. The packing member 320 is pressed against by the packing cover 310. Accordingly, the gap between the guide sleeve 420 and the upper hole 332/lower hole 333 of the gasket body 330 is sealed by the packing member 320. Thus, wash liquid that flows through the guide sleeve 420 is prevented from leaking through the upper hole 332/lower hole 333 of the gasket body 330.

When large dishes are stored in the upper rack 120, the height of the upper rack 120 must be lowered a level. In this case the spray arm holder 200 must also be lowered a notch as well.

In detail, to install the spray arm holder 200 at a low level, the middle pin 412 inserts through the guide pin insert hole 331 of the gasket body 330 and the guide pin insert hole 221 of the gasket cover 220. The guide sleeve 420 inserts through the upper hole 332 of the gasket body 330, the upper hole 321 of the packing member 320, and the upper hole 311 of the packing cover 310. The lower pin 413 inserts through the lower hole 333 of the gasket body 330, the lower hole 322 of the packing member 320, and the lower hole 312 of the packing cover 310.

Here, the respective outer surfaces of the guide sleeve 420 and the lower pin 413 seal the respective inner surfaces of the packing sleeves 323 and 324 of the packing member 320. The packing cover 310 presses against the packing member 320. Accordingly, the gap between the guide sleeve 420 and the upper hole 332/lower hole 333 of the gasket body 330 is sealed by the packing member 320. Thus, wash liquid that flows through the guide sleeve 420 is prevented from leaking through the upper hole 332/lower hole 333 of the gasket body 330.

In addition, because the lower pin 413 inserts into the lower hole 322 of the packing member 320, the lower hole 322 can be blocked. Therefore, wash liquid that flows to the spray arm holder 200 through the guide sleeve 420 is prevented from leaking through the lower hole 322. Accordingly, a packing mouth or similar device according to the related art is not required for preventing leaks in a dishwasher according to the present invention.

The above-described dishwasher improves the structure of a packing member, so that leakage through a connecting portion can be prevented while wash liquid flows from a water guide to an upper spray arm holder.

Furthermore, even if the coupling position of the spray arm holder is altered on the water guide, leakage of wash liquid through the connecting portion can be prevented.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a water guide;
a spray arm holder for receiving wash liquid flowing through the water guide;
a guide pin protruding from the water guide;
a guide sleeve providing a passage for a flow of wash liquid from the water guide to the spray arm holder; and
a gasket including a gasket body forming a hole for inserting the guide pin and the guide sleeve through, and a packing member for sealing a gap between the gasket body and the guide sleeve to prevent leakage between the water guide and the spray arm holder.

2. The dishwasher according to claim 1, wherein the packing member has a hole through which the guide sleeve inserts.

3. The dishwasher according to claim 2, wherein the hole through which the guide sleeve inserts has a packing sleeve formed to protrude a predetermined height from an outer perimeter thereof.

4. The dishwasher according to claim 3, wherein the packing sleeve has an inner surface that seals against an outer surface of the guide sleeve.

5. The dishwasher according to claim 1, wherein the packing member and the gasket body are pressed together.

6. The dishwasher according to claim 1, wherein the gasket further includes a packing cover for pressing against the packing member.

7. The dishwasher according to claim 1, wherein the guide pin is formed above and below the guide sleeve.

8. The dishwasher according to claim 1, wherein the packing member forms a hole for inserting the guide pin through.

9. The dishwasher according to claim 8, wherein the hole for inserting the guide pin through has an inner surface that seals against an outer surface of the guide pin.

10. The dishwasher according to claim 1, wherein the packing member is made of a rubber material.

11. A gasket of a dishwasher having a spray arm holder, a guide sleeve providing a passage for a flow of wash liquid to the spray arm holder, and a water guide forming a guide pin protruding therefrom, wherein the gasket comprises:
a gasket body forming a hole for inserting the guide pin and the guide sleeve therethrough; and
a packing member for sealing a gap between the gasket body and the guide sleeve to prevent leakage between the water guide and the spray arm holder.

12. The gasket according to claim 11, wherein the packing member forms a hole for inserting the guide sleeve through.

13. The gasket according to claim 12, wherein the hole that the guide sleeve inserts through has a packing sleeve formed a predetermined height from an outer perimeter thereof.

14. The gasket according to claim 11, wherein the packing member forms a hole for inserting the guide pin through.

15. The gasket according to claim 11, wherein the packing member is made of a rubber material.

16. A dishwasher comprising:
a water guide;
a spray arm holder for receiving wash liquid flowing through the water guide;
a guide sleeve providing a passage for a flow of wash liquid from the water guide to the spray arm holder;
a guide pin formed above and below the guide sleeve; and
a gasket including a gasket body forming a hole for inserting the guide pin and the guide sleeve through, a packing member for sealing a gap between the gasket body and the guide sleeve to prevent leakage between the water guide and the spray arm holder, and a packing cover for pressing against the packing member.

17. The dishwasher according to claim 16, wherein the packing member forms a hole for inserting the guide sleeve through, and the hole through which the guide sleeve inserts has a packing sleeve formed to protrude a predetermined height from an outer periphery thereof.

18. The dishwasher according to claim 17, wherein the packing sleeve has an inner surface that seals with an outer surface of the guide sleeve.

19. The dishwasher according to claim 16, wherein the packing member and the gasket body are pressed together.

20. The dishwasher according to claim 16, wherein the packing member forms a hole for inserting the guide pin through, and the hole through which the guide pin inserts has an inner surface that seals with an outer surface of the guide pin.
